(19) United States
(12) Patent Application Publication
(10) Pub. No.: US 2026/0116905 A1
(43) Pub. Date: Apr. 30, 2026

(54) SYNTHESIS OF PALLADIUM(0) PHOSPHINE COMPLEXES

(71) Applicant: SIGMA-ALDRICH CO. LLC, St. Louis, MO (US)

(72) Inventors: Preston MACQUEEN, St. Louis, MO (US); Thomas COLACOT, Burlington, MA (US)

(73) Assignee: SIGMA-ALDRICH CO. LLC, St. Louis, MO (US)

(21) Appl. No.: 19/116,819

(22) PCT Filed: Sep. 6, 2023
(86) PCT No.: PCT/US2023/073550

§ 371 Date: Mar. 28, 2025

Related U.S. Application Data
(60) Provisional application No. 63/377,558, filed on Sep. 29, 2022.
(60) Provisional application No. 63/481,731, filed on Jan. 26, 2023.

(51) Int. Cl. C07F 15/00

(52) U.S. Cl. CPC C07F 15/0066

(57) ABSTRACT

Provided is an optimized process for the synthesis of palladium(0) phosphine complexes. The process described herein is characterized by a more efficient reaction control, high yield and purity, the use of readily available starting materials, and savings in reaction time and steps, thereby offering increased sustainability when compared to processes reported in the state of the art.

### CROSS-REFERENCE TO RELATED APPLICATIONS

The present application claims the benefit of priority of U.S. provisional patent application No. 63/377,558, filed on Sep. 29, 2022, and U.S. provisional patent application No. 63/481,731, filed on Jan. 26, 2023, wherein both of their entire content is incorporated herein in its entirety.

### FIELD OF INVENTION

Provided is an optimized process for the synthesis of palladium(0) phosphine complexes such as e.g. bis(tri-tert-butylphosphine)palladium(0).

The synthesis process starts from commercially available palladium(II) compounds, which are reduced to palladium(0) complexes in situ by addition of excess phosphine ligand. The obtained palladium(0) complex is then purified in situ by e.g. precipitating and washing, and isolated with high yield and purity. The synthesis process does not require the addition of reducing agents such as, for example, alkali metal hydroxides or alkali metal alkoxides, in particular, for example, sodium hydroxide or sodium methoxide (which may be prepared from sodium hydroxide in methanol under controlled conditions). Furthermore, the synthesis process can be carried out in a single reaction vessel as a one-pot reaction.

### BACKGROUND

Over the past decades, palladium-catalyzed cross-coupling reactions have emerged ed as one of the most powerful tools in organic synthesis.^{(1a-c)} Although both Pd(II) and P(0) complexes can facilitate the cross-coupling catalysis, it is well established that LₙPd(0) (n=number of ligands) is the active species in the catalytic cycle.^{(1c)} Due to practical and safety reasons, there is an increasing interest in using preformed (R₃P)₂Pd(0) catalysts for cross-coupling reactions.^{(1b),(2)} Various methods of preparation have been reported in literature, which either lack generality or employ tedious isolation techniques.

For example, bis(tri-tert-butylphosphine)palladium(0) is a popular catalyst for cross-coupling reactions in both academia and industry synthetic chemistry communities. Methods to produce this material typically involve air sensitive Pd(0) starting materials such as Pd(dba)₂ originally by the Hartwig group⁽³⁾ and modified by others^{(4),(5)} or from Pd(II) allyl compounds.^{(6),(7)}

Improved methods have been developed that use an air stable Pd(II) source, but these require an additional reducing agent such as sodium hydroxide,⁽⁸⁾⁻⁽¹⁰⁾ hydrogen,⁽¹¹⁾ or bis(pinacolato)diboron under controlled conditions.⁽¹²⁾

The synthesis process according to the present invention uses a palladium(II) compound, such as e.g. dichloro(1,5-cyclooctadiene)palladium(II), as the starting materials, which is reduced to Pd(0) in situ by addition of excess phosphine ligand and then purified by e.g. precipitating and washing to obtain the desired product in high yield and purity (e.g. >87% yield, >98% purity) from a single flask. Unlike previously reported methods, this process does not rely on Pd(0) starting materials⁽³⁾⁻⁽⁵⁾, temperature sensitive palladium alkene dimers as starting materials^{(6),(7)}, or additional reducing agents under controlled conditions including low temperature synthesis of intermediates.⁽⁸⁾⁻⁽¹²⁾

Colacot et al.^{(8),(9)} reported a synthesis in which 1 equivalent of dibromo(1,5-cyclooctadiene)palladium(II) is reacted in a two-step, synthesis with 2 equivalents of NaOH in MeOH as a solution and 2 equivalents of tri-tert-butylphosphine ligand in toluene at low temperature. The synthesis of MeONa from NaOH and MeOH is a very exothermic process which needs to be carried out separately under controlled conditions The reported isolated yield is ca 95%.

Colacot et al.⁽¹⁰⁾ reported in a mechanistic study on the formation of bis(tri-tert-butylphosphine)palladium(0) from dibromo(1,5-cyclooctadiene)palladium(II) and 3 equivalents of tri-tert-butylphosphine a yield of 71% and 95% purity with 5% of the corresponding palladium(I) bromide dimer.

Hence, there is still a continuous need to develop improved syntheses for palladium(0) phosphine complexes, especially bis(tri-tert-butylphosphine)palladium(0), relatively easily using ambient conditions, which are characterized by a more efficient reaction control, comparable isolated yield and purity, the use of readily available starting materials, and savings in reaction time and steps, thereby offering increased sustainability.

### SUMMARY

The present invention provides a process for synthesizing a palladium(0) phosphine complex, wherein said process comprises the following steps:
(a) reacting a palladium(II) compound with about 3 or more equivalents of a phosphine ligand to obtain a palladium(0) phosphine complex, wherein the equivalents are based on the amount of palladium(II); and
(b) in situ purification of the palladium(0) phosphine complex obtained in step (a).

The present invention further provides a palladium(0) phosphine complex obtainable by the process according to the present invention.

### BRIEF DESCRIPTION OF THE FIGURES

None

### DETAILED DESCRIPTION

Herein is described a process for synthesizing a palladium(0) phosphine complex, wherein said process comprises the following steps:
(a) reacting a palladium(II) compound with about 3 or more equivalents of a phosphine ligand to obtain a palladium(0) phosphine complex, wherein the equivalents are based on the amount of palladium(II); and
(b) in situ purification of the palladium(0) phosphine complex obtained in step (a).

The process for synthesizing a palladium(0) phosphine complex described herein overcomes the problems with conventional processes for synthesizing palladium(0) phosphine complexes and thereby provides a powerful scalable new synthetic route towards catalysts based on palladium(0) phosphine complexes, especially geared for the production of bis(tri-tert-butylphosphine)palladium(0), which is a commercial catalyst utilized for many organic transformations.

The process described herein provides the following advantages:

The process makes use of air stable Pd(II) starting materials rather than air/temperature sensitive Pd precursors. The process does not require any additional reducing agents as the additional equivalent of phosphine is used as a reducing agent. In particular, the process does not require any basic reducing agents such as, for example, alkali metal hydroxides or alkali metal alkoxides, in particular, for example, sodium hydroxide in MeOH or sodium methoxide.

The entire process can be completed in a single reaction vessel as a one-pot reaction. The process involves only a one-step reaction to obtain a palladium(0) phosphine complex from the starting materials, followed by simple in situ purification via preferably precipitation and washing. This means that the product is formed directly in a one-step reaction and no intermediates occur, making the process more robust. The one-step reaction can be carried out a room temperature (about 20° C. to about 25° C.) versus low temperature synthesis or cryogenic crystallization, e.g. at −30° C. This is followed by simple in situ purification.

The process can utilize tetrachloropalladate(II) salts of lithium, sodium, potassium or ammonium as starting material, which are inexpensive Pd(II) sources and have less impact on the environment. Alternatively, Pd(II) compounds such as, for example, (RCN)₂PdX₂ (R=Me, Ph, etc.; X=Cl, Br, I), Pd(olefin)X₂ (olefin=norbornadiene, cyclooctadiene, etc.; X=Cl, Br, I), [Pd(π-allyl)X]₂ (X=Cl, Br, I), etc. can be used.

The process provides high yield and purity compared to literature known processes even at larger scale.

In summary, the process described herein provides a more efficient reaction control, allows the use of more readily available and cheaper starting materials, and saves on reagents and energy, thereby offering increased sustainability when compared to literature known processes. Besides it is more robust for scale up.

In a preferred embodiment of the present invention, the palladium(II) compound is represented by Formula (I), (II), (III), (IV) or (V):

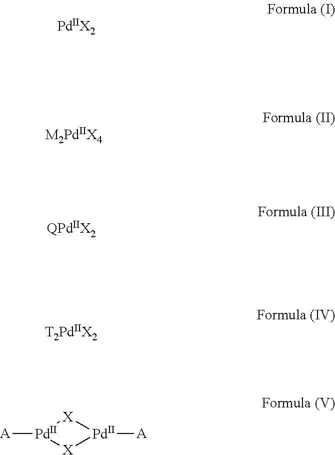

wherein:
M is an alkali metal cation or ammonium cation, preferably selected from Li⁺, Na⁺, K⁺, Rb⁺, Cs⁺ and NH₄⁺, more preferably selected from Li⁺, Na⁺ and NH₄⁺, and most preferably selected from Na⁺ and NH₄⁺;
X is a halogen anion, preferably selected from Cl⁻, Br⁻ and I⁻, more preferably selected from Cl⁻ and Br⁻, and most preferably Cl⁻;
Q is a cyclic diene, preferably selected from 1,5-cyclooctadiene and bicyclo[2.2.1]hepta-2,5-diene;
T is a nitrile, preferably selected from acetonitrile and benzonitrile, or an olefin, preferably ethylene; and
A is an alkene, preferably selected from an allyl compound, crotyl compound and cinnamyl compound, more preferably selected from allyl, crotyl and cinnamyl.

In a more preferred embodiment of the present invention, the palladium(II) compound is represented by Formula (I), (II), (III), (IV) or (V):

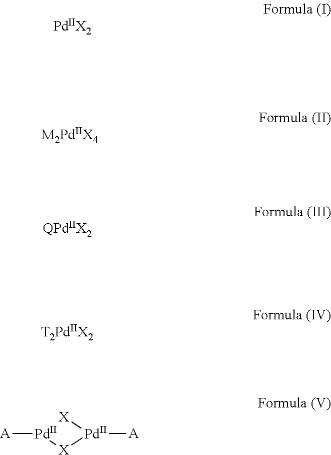

wherein:
M is selected from Li⁺, Na⁺, K⁺, Rb⁺, Cs⁺ and NH₄⁺;
X is selected from Cl⁻, Br⁻ and I⁻;
Q is selected from 1,5-cyclooctadiene and bicyclo[2.2.1]hepta-2,5-diene;
T is selected from acetonitrile, benzonitrile and ethylene; and
A is selected from an allyl compound, crotyl compound and cinnamyl compound.

In a particularly preferred embodiment of the present invention, the palladium(II) compound is represented by Formula (I), (II), (III), (IV) or (V):

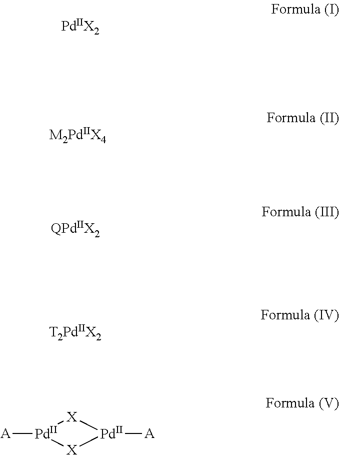

wherein:
M is selected from Li⁺, Na⁺ and NH₄⁺;
X is selected from Cl⁻ and Br⁻;
Q is selected from 1,5-cyclooctadiene and bicyclo[2.2.1]hepta-2,5-diene;
T is selected from acetonitrile and benzonitrile; and
A is selected from an allyl compound, crotyl compound and cinnamyl compound.

In a most preferred embodiment of the present invention, the palladium(II) compound is represented by Formula (I), (II), (III), (IV) or (V):

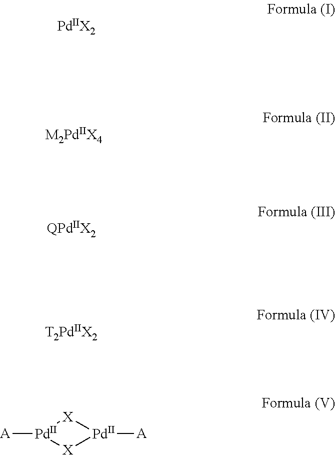

wherein:
M is selected from Na⁺ and NH₄⁺;
X is Cl⁻;
Q is selected from 1,5-cyclooctadiene and bicyclo[2.2.1]hepta-2,5-diene;
T is selected from acetonitrile and benzonitrile; and
A is selected from allyl, crotyl and cinnamyl.

Preferred palladium(II) compounds are:

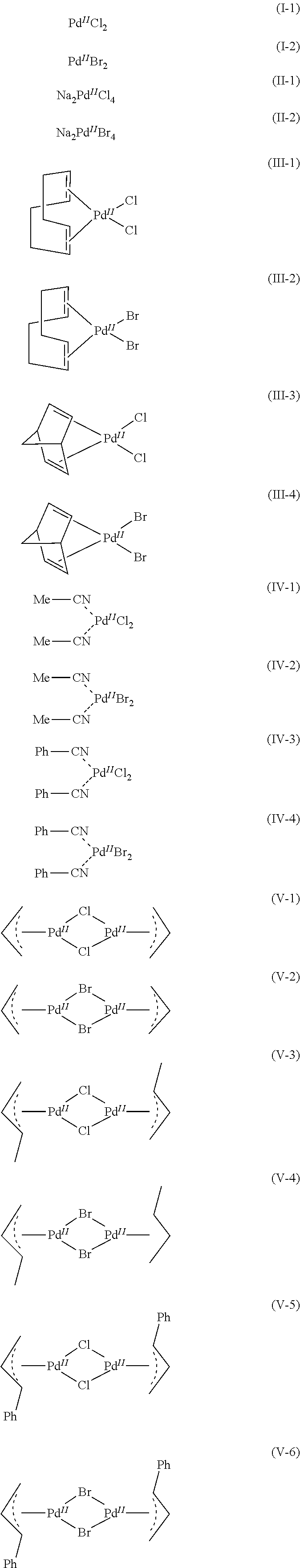

More preferred palladium(II) compounds are:

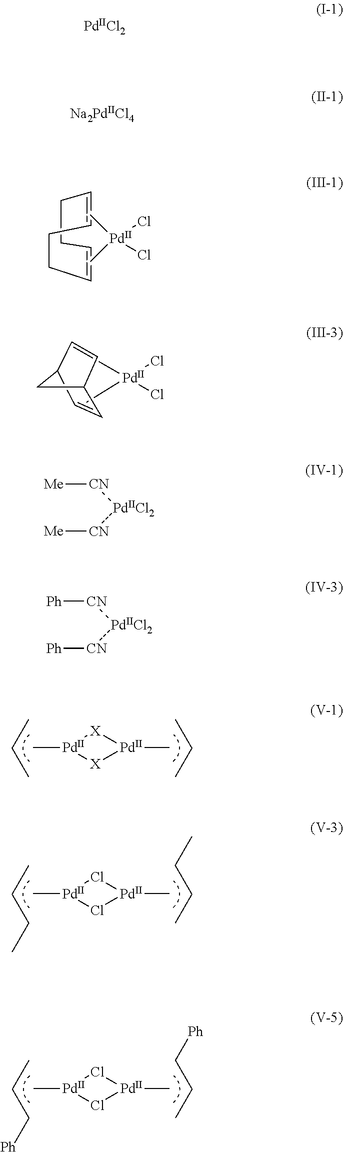

In a preferred embodiment of the present invention, the phosphine ligand is represented by Formula (VI) and the palladium(0) phosphine complex is represented by Formula (VII):

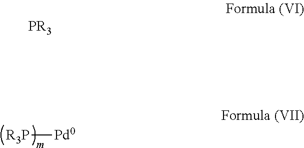

wherein:
R is at each occurrence independently from each other selected from alkyl, cycloalkyl, aryl, and alkylaryl, which are optionally substituted, preferably R is at each occurrence independently from each other selected from C₁-C₁₀ alkyl, C₃-C₁₀ cycloalkyl, C₆-C₁₄ aryl, and C₇-C₁₅ alkylaryl, which are optionally substituted by one or more substituents selected from F, Cl, CN, and —SO₃M, wherein M is an alkali metal cation or ammonium cation, more preferably R is at each occurrence independently from each other selected from C₁-C₅ alkyl, C₃-C₆ cycloalkyl, C₆-C₁₀ aryl, and C₇-C₁₁ alkylaryl, which are optionally substituted by one or more substituents selected from F, Cl, CN, and —SO₃M, wherein M is selected from Li⁺, Na⁺, K⁺, Rb⁺, Cs⁺ and NH₄⁺, most preferably R is at each occurrence independently from each other selected from methyl, ethyl, propyl, butyl, pentyl, cyclopropyl, cyclobutyl, cyclopentyl, cyclohexyl, phenyl, and tolyl, which are optionally substituted by one or more —SO₃M, wherein M is selected from Li⁺, Na⁺ and NH₄⁺; and
m is 2, 3 or 4.

In a more preferred embodiment of the present invention, the phosphine ligand is represented by Formula (VI) and the palladium(0) phosphine complex is represented by Formula (VII):

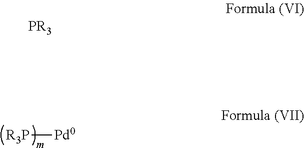

wherein:
R is at each occurrence independently from each other selected from C₁-C₁₀ alkyl, C₃-C₁₀ cycloalkyl, C₆-C₁₄ aryl, and C₇-C₁₅ alkylaryl, which are optionally substituted by one or more substituents selected from F, Cl, CN, and —SO₃M, wherein M is an alkali metal cation or ammonium cation; and
m is 2, 3 or 4.

In a particularly preferred embodiment of the present invention, the phosphine ligand is represented by Formula (VI) and the palladium(0) phosphine complex is represented by Formula (VII):

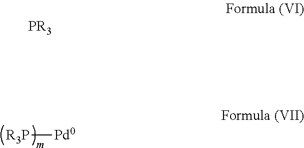

wherein:
R is at each occurrence independently from each other selected from C₁-C₅ alkyl, C₃-C₆ cycloalkyl, C₆-C₁₀ aryl, and C₇-C₁₁ alkylaryl, which are optionally substituted by one or more substituents selected from F, Cl, CN, and —SO₃M, wherein M is selected from Li⁺, Na⁺, K⁺, Rb⁺, Cs⁺ and NH₄⁺; and
m is 2, 3 or 4.

In a most preferred embodiment of the present invention, the phosphine ligand is represented by Formula (VI) and the palladium(0) phosphine complex is represented by Formula (VII):

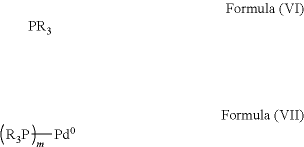

wherein:
R is at each occurrence independently from each other selected from methyl, ethyl, propyl, butyl, pentyl, cyclopropyl, cyclobutyl, cyclopentyl, cyclohexyl, phenyl, and tolyl, which are optionally substituted by one or more —SO₃M, wherein M is selected from Li⁺, Na⁺ and NH₄⁺; and
m is 2, 3 or 4.

A very most preferred phosphine ligand according to Formula (V) is:

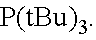

A very most preferred palladium(0) phosphine complex according to Formula (VI) is:

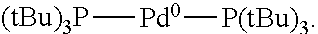

In a preferred embodiment of the present invention, in step (a) the palladium(II) compound is reacted with 3 or more equivalents of the phosphine ligand to obtain the palladium(0) phosphine complex, wherein the equivalents are based on the amount of palladium(II).

In a more preferred embodiment of the present invention, in step (a) the palladium(II) compound is reacted with about 3 to about 6 equivalents of the phosphine ligand to obtain the palladium(0) phosphine complex, wherein the equivalents are based on the amount of palladium(II).

In an even more preferred embodiment of the present invention, in step (a) the palladium(II) compound is reacted with 3 to 6 equivalents of the phosphine ligand to obtain the palladium(0) phosphine complex, wherein the equivalents are based on the amount of palladium(II).

In a most preferred embodiment of the present invention, in step (a) the palladium(II) compound is reacted with about 3 to about 4 equivalents of the phosphine ligand to obtain the palladium(0) phosphine complex, wherein the equivalents are based on the amount of palladium(II).

In an even most preferred embodiment of the present invention, in step (a) the palladium(II) compound is reacted with 3 to 4 equivalents of the phosphine ligand to obtain the palladium(0) phosphine complex, wherein the equivalents are based on the amount of palladium(II).

In a preferred embodiment of the present invention, step (a) is carried out at room temperature.

In a preferred embodiment of the present invention, step (a) is carried out at a temperature between about 20° C. to about 25° C.

In a preferred embodiment of the present invention, step (a) is carried out in an aromatic hydrocarbon solvent.

In a more preferred embodiment of the present invention, step (a) is carried out in toluene.

In a preferred embodiment of the present invention, in step (b) the palladium(0) phosphine complex obtained in step (a) is purified by precipitating from a first solvent and washing with a second solvent, wherein the first solvent is a hydrocarbon and the second solvent is an alcohol. Preferably, the first solvent is a C₆-C₁₄ aromatic hydrocarbon. More preferably, the first solvent is benzene or toluene. Most preferably, the first solvent is toluene. Preferably, the second solvent is a C₁-C₁₀ alcohol. More preferably, the second solvent is selected from methanol, ethanol, propanol and butanol. Most preferably, the second solvent is methanol.

In a preferred embodiment of the present invention, precipitating from the first solvent is performed by adding the first solvent.

In a preferred embodiment of the present invention, precipitating from the first solvent is performed by adding the second solvent.

In a preferred embodiment of the present invention, washing with the second solvent is carried out at a temperature between about −20° C. to about 20° C.

In a more preferred embodiment of the present invention, washing with the second solvent is carried out at a temperature between about −20° C. to about −10° C.

In a most preferred embodiment of the present invention, washing with the second solvent is carried out at a temperature of about −10° C.

In a preferred embodiment of the present invention, washing with the second solvent is repeated until a clear and colorless filtrate is obtained.

In a preferred embodiment of the present invention, step (b) is carried out twice or more times in succession. In a more preferred embodiment of the present invention, step (b) is carried out twice or three times in succession.

In a preferred embodiment of the present invention, the process for synthesizing a palladium(0) phosphine complex is carried out in a single reaction vessel.

In a preferred embodiment of the present invention, the process for synthesizing a palladium(0) phosphine complex does not involve the addition of basic reducing agents such as, for example, alkali metal hydroxides or alkali metal alkoxides, in particular, for example, sodium hydroxide or sodium methoxide.

The present invention further relates to a palladium(0) phosphine complex obtainable by the process for synthesizing described herein above.

### Definitions

As used herein, the term “about” or “approximately”, when used in connection with a measurable numerical variable, refers to the indicated value of the variable and to all values of the variable that tare within the experimental error of the indicated value (e.g., within 95% confidence limit for the mean) or within ±10%, preferably ±5%, of the indicated value, whichever is greater.

As used herein, the term “tBu” refers to a tert-butyl group, i.e. a branched alkyl group of formula (—C₄H₉), which may also be written as (—C(CH₃)₃).

As used herein, the term “alkyl” refers to a saturated hydrocarbon chain, such as, but not limited to, methyl, ethyl, propyl and butyl. The alkyl group may be straight-chain or branched-chain. For example, as used herein, propyl encompasses both n-propyl and iso-propyl; butyl encompasses n-butyl, sec-butyl, iso-butyl and tert-butyl, and so forth.

As used herein, the term “cycloalkyl” refers to a saturated hydrocarbon cyclic group, such as, but not limited to, cyclopropyl, cyclobutyl, cyclopentyl and cyclohexyl. Also included are bridged saturated hydrocarbon (poly)cyclic groups such as, but not limited to, adamantyl.

As used herein, the term “aryl” refers to an aromatic hydrocarbon group. Aryl includes, e.g., phenyl, biphenyl, naphthyl, anthracenyl, and so forth, as well as the substituted forms of each.

As used herein, the term “allyl” refers to a substituent with the structural formula R—CH₂—CH═CH₂, where R is the rest of the molecule or H. It consists of a methylene bridge (—CH₂—) attached to a vinyl group (—CH═CH₂).

As used herein, the term “crotyl” refers to a substituent with the structural formula R—CH₂—CH═CH—CH₃, where R is the rest of the molecule or H. Systematically, it is called a but-2-en-1-yl group and exhibits geometric isomerism, being either cis (Z) or trans (E).

As used herein, the term “cinnamyl” refers to a substituent with the structural formula R—CH₂—CH═CH-Ph, where R is the rest of the molecule or H. Systematically, it is called a 3-phenylprop-2-enyl group and exhibits geometric isomerism, being either cis (Z) or trans (E).

“Substituted” as used herein means that one or more hydrogen atoms of the described compound or functional group is replaced with another functional group, or substituent. For example, substituted phenyl may include one or more substituents in place of any hydrogen atom on the phenyl ring. In some embodiment, there may be one substituent at the ortho, meta or para position. In other embodiments, there may be substituents at both ortho positions or both meta positions. In still other embodiments, the optionally substituted phenyl may include substituents at, e.g., both the ortho and para positions, or both meta and para positions. In some embodiments with multiple substituents, the substituents are all the same, in other embodiments with multiple substituents, the substituents are different from each other. Typical substituents include, but are not limit to, C₁-C₄ alkyl, C₁-C₄ haloalkyl and C₁-C₄ alkoxy. When a functional group is described as “optionally substituted” that functional group may have one or more substituents or no substituents.

### EXAMPLES

### Example 1. Synthesis of Bis(tri-tert-butylphosphine)palladium(0) from Dichloro(1,5-cyclooctadiene)palladium(II)

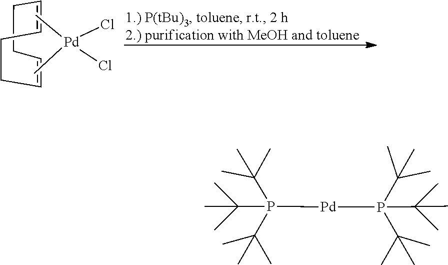

Dichloro(1,5-cyclooctadiene)palladium(II), 99% (10.00 g; 35.03 mmol; 1.00 eq.) was added to a flask with a stir bar and a thermometer or thermocouple probe. It was purged with nitrogen for 30 minutes. A 1 molar solution of tri-tert-butylphosphine, 98% (22.68 g; 112.08 mmol; 3.20 eq.) in toluene was added to the flask via nitrogen pressure cannula transfer or syringe. The reaction mixture was stirred for 2 hours at room temperature (20-25° C.).

Degassed methyl alcohol (anhydrous, 99.8% (120.00 ml)) was added to the flask and the reaction mixture was allowed to stir for 20-30 minutes. Then, the reaction mixture was cooled to −10 to −20° C. and the solids were allowed to settle. The liquid was filtered away with a canula and it was washed with more methanol until the filtrate is clear and colorless. Then, toluene (anhydrous, 99.8% (75 ml) was added to the flask and it was stirred at 55-60° C. for 30 min. The reaction mixture was allowed to cool to at least 30° C. and degassed methyl alcohol (anhydrous, 99.8% (120.00 ml)) was added to the flask. The reaction mixture was allowed to stir for 20-30 minutes. Then, the reaction mixture was cooled to −10 to −20° C. and the solids were allowed to settle. The liquid was filtered away with a canula and it was washed with more methanol until the filtrate is clear and colorless. The slurry was transferred onto a Schlenk filter under vacuum for filtration. The white solid product was dried under inert conditions.

Yield: 87%, purity: >98%. 1H NMR (C₆D₆, 500 MHz): δ=1.51 (t, 54H) ppm. 31P{1H} NMR (C₆D₆, 202 MHz): δ=84.8 ppm.

### Example 2. Synthesis of Bis(tri-tert-butylphosphine)palladium(0) from Dichloro(norbornadiene)palladium(II)

The procedure of Example 1 was repeated using dichloro(norbornadiene)palladium(II), 99% (2.00 g; 7.42 mmol; 1.00 eq.) instead of dichloro(1,5-cyclooctadiene)palladium(II). The quantitative ratios and volumes of the used reagents and solvents were adjusted accordingly. The desired product was obtained in 80% yield.

### Example 3. Synthesis of Bis(tri-tert-butylphosphine)palladium(0) from Bis(acetonitrile)dichloropalladium(II)

The procedure of Example 1 was repeated using bis(acetonitrile)dichloropalladium(II), 99% (2.00 g; 7.71 mmol; 1.00 eq.) instead of dichloro(1,5-cyclooctadiene)palladium(II). The quantitative ratios and volumes of the used reagents and solvents were adjusted accordingly. The desired product was obtained in 70% yield.

### Example 4. Synthesis of Bis(tri-tert-butylphosphine)palladium(0) from Bis(benzonitrile)dichloropalladium(II)

The procedure of Example 1 was repeated using bis(benzonitrile)dichloropalladium(II), 99% (2.00 g; 5.21 mmol; 1.00 eq.) instead of dichloro(1,5-cyclooctadiene)palladium(II). The quantitative ratios and volumes of the used reagents and solvents were adjusted accordingly. The desired product was obtained in 78% yield.

The examples provided herein are not meant to limit the scope of the invention as set forth in the claims.

### REFERENCES

(1a) P. G. Gildner, T. J. Colacot, Reactions of the 21st Century: Two Decades of Innovative Catalyst Design for Palladium-Catalyzed Cross-Couplings, Organometallics 2015, 34, 5497-5508.
(1b) H. Li, C. C. C. Johansson Seechurn, T. J. Colacot, Development of Preformed Pd Catalysts for Cross-Coupling Reaction, Beyond the 2010 Nobel Prize, ACS Catal. 2012, 2, 6, 1147-1164.
(1c) C. C. C. Johansson Seechurn, M. O. Kitching, T J. Colacot, V, Snieckus, Palladium-Catalyzed Cross-Coupling: A Historical Contextual Perspective to the 2010 Nobel Prize, Angew. Chem. Int. Ed. 2012, 51, 5062-5085.
(2) G. C. Fu, The Development of Versatile Methods for Palladium-Catalyzed Coupling Reaction of Aryl Electrophiles through the Use of P(t-Bu)₃ and PCy₃ as Ligands, Acc. Chem. Res. 2008, 41, 11, 1555-1564.
(3) F. Paul, J. Patt, J. F. Hartwig, Structural Characterization and Simple Synthesis of {Pd[P(o-Tol)₃]2}, Dimeric Palladium(II) Complexes Obtained by Oxidative Addition of Aryl Bromides, and Corresponding Monometallic Amine Complexes, Organometallics 1995, 14, 3030-3039.
(4) A. F. Littke, G. C. Fu, Heck Reactions of Aryl Chlorides Catalyzed by Palladium/Tri-tert-Butylphosphine: (E)-2-Methyl-3-Phenylacrylic Acid Butyl Ester and (E)-4-(2-Phenylethenyl)Benzonitrile, Organic Syntheses 2005, 81, 63-76.
(5) CN 101693725 A.
(6) D. M. Norton, E. A. Mitchell, N. R. Botros, P. G. Jessop, M. C. Baird, A Superior Precursor for Palladium(0)-Based Cross-Coupling and Other Catalytic Reactions, J. Org. Chem. 2009, 74, 6674-6680.
(7) J. S. Quesnel, L. V. Layser, A. Fabrikant, B. A. Arndtsen, Acid Chloride Synthesis by the Palladium-Catalyzed Chlorocarbonylation of Aryl Bromides, Chem. Eur. J. 2015, 21, 9950-9555.
(8) WO 2010/128316 A1
(9) H. Li, G. A. Grasa, T. J. Colacot, A Highly Efficient, Practical, and General Route for the Synthesis of (R₃P)₂Pd(0): Structural Evidence on the Reduction Mechanism of Pd(II) to Pd(0), Org. Lett. 2010, 12, 3332-3335.
(10) C. C. C. Johansson Seechurn, T. Sperger, T. G. Scrase, F. Schoenebeck, T. J. Colacot, Understanding the Unusual Reduction Mechanism of Pd(II) to Pd(I): Uncovering Hidden Species and Implications in Catalytic Cross-Coupling Reactions, J. Am. Chem. Soc. 2017, 139, 5194-5200.
(11) W. H. Henderson, J. M. Alvarez, C. C. Eichman, J. P. Stambuli, Characterization, Reactivity, and Potential Catalytic Intermediacy of a Cyclometalated Tri-tert-butylphosphine Palladium Acetate Complex, Organometallics, 2011, 30, 5038-5044.
(12) C. S. Wei, G. H. M. Davies, O. Soltani, J. Albrecht, Q. Gao, C. Pathirana, Y. Hsiao, S. Tummala, M. D. Eastgate, The Impact of Palladium(II) Reduction Pathways on the Structure and Activity of Palladium(0) Catalysts, Angew. Chem. Int. Ed. 2013, 52, 5822-5826.

1. A process for synthesizing a palladium(0) phosphine complex, wherein said process comprises the following steps:
(a) reacting a palladium(II) compound with about 3 or more equivalents of a phosphine ligand to obtain a palladium(0) phosphine complex, wherein the equivalents are based on the amount of palladium(II); and
(b) in situ purification of the palladium(0) phosphine complex obtained in step (a).

2. The process according to claim 1, wherein the palladium(II) compound is represented by Formula (I), (II), (III), (IV) or (V): 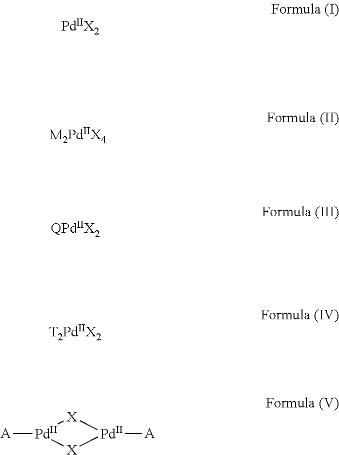
wherein:
M is an alkali metal cation or ammonium cation;
X is a halogen anion;
Q is a cyclic diene;
T is a nitrile or an olefin; and
A is an alkene.

3. The process according to claim 2, wherein:
M is selected from Li⁺, Na⁺, K⁺, Rb⁺, Cs⁺ and NH₄⁺;
X is selected from Cl⁻, Br⁻ and I⁻;
Q is selected from 1,5-cyclooctadiene and bicyclo[2.2.1]hepta-2,5-diene;
T is selected from acetonitrile, benzonitrile and ethylene; and
A is selected from an allyl compound, crotyl compound and cinnamyl compound.

4. The process according to claim 2, wherein:
M is selected from Li⁺, Na⁺ and NH₄⁺;
X is selected from Cl⁻ and Br⁻;
Q is selected from 1,5-cyclooctadiene and bicyclo[2.2.1]hepta-2,5-diene;
T is selected from acetonitrile and benzonitrile; and
A is selected from an allyl compound, crotyl compound and cinnamyl compound.

5. The process according to claim 2, wherein:
M is selected from Na⁺ and NH₄⁺;
X is Cl⁻;
Q is selected from 1,5-cyclooctadiene and bicyclo[2.2.1]hepta-2,5-diene;
T is selected from acetonitrile and benzonitrile; and
A is selected from allyl, crotyl and cinnamyl.

6. The process according to claim 1, wherein the phosphine ligand is represented by Formula (V) and the palladium(0) phosphine complex is represented by Formula (VI): 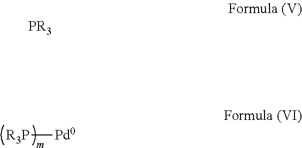
wherein:
R is at each occurrence independently from each other selected from alkyl, cycloalkyl, aryl, and alkylaryl, which are optionally substituted; and
m is 2, 3 or 4.

7. The process according to claim 6, wherein:
R is at each occurrence independently from each other selected from C₁-C₁₀ alkyl, C₃-C₁₀ cycloalkyl, C₆-C₁₄ aryl, and C₇-C₁₅ alkylaryl, which are optionally substituted by one or more substituents selected from F, Cl, CN, and —SO₃M, wherein M is an alkali metal cation or ammonium cation; and
m is 2, 3 or 4.

8. The process according to claim 6, wherein:
R is at each occurrence independently from each other selected from C₁-C₅ alkyl, C₃-C₆ cycloalkyl, C₆-C₁₀ aryl, and C₇-C₁₁ alkylaryl, which are optionally substituted by one or more substituents selected from F, Cl, CN, and —SO₃M, wherein M is selected from Li⁺, Na⁺, K⁺, Rb⁺, Cs⁺ and NH₄⁺; and
m is 2, 3 or 4.

9. The process according to claim 6, wherein:
R is at each occurrence independently from each other selected from methyl, ethyl, propyl, butyl, pentyl, cyclopropyl, cyclobutyl, cyclopentyl, cyclohexyl, phenyl, and tolyl, which are optionally substituted by one or more —SO₃M, wherein M is selected from Li⁺, Na⁺ and NH₄⁺; and
m is 2, 3 or 4.

10. The process according to claim 1, wherein in step (a) the palladium(II) compound is reacted with about 3 to about 6 equivalents of the phosphine ligand to obtain the palladium(0) phosphine complex, wherein the equivalents are based on the amount of palladium(II).

11. The process according to claim 1, wherein in step (a) the palladium(II) compound is reacted with about 3 to about 4 equivalents of the phosphine ligand to obtain the palladium(0) phosphine complex, wherein the equivalents are based on the amount of palladium(II).

12. The process according to claim 1, wherein step (a) is carried out at room temperature.

13. The process according to claim 1, wherein step (a) is carried out at a temperature between about 20° C. to about 25° C.

14. The process according to claim 1, wherein step (a) is carried out in an aromatic hydrocarbon solvent.

15. The process according to claim 1, wherein step (a) is carried out in toluene.

16. The process according to claim 1, wherein in step (b) the palladium(0) phosphine complex obtained in step (a) is purified by precipitating and washing.

17. The process according to claim 1, wherein in step (b) the palladium(0) phosphine complex obtained in step (a) is purified by precipitating from a first solvent and washing with a second solvent, wherein the first solvent is a hydrocarbon and the second solvent is an alcohol.

18. The process according to claim 17, wherein the first solvent is a C₆-C₁₄ aromatic hydrocarbon.

19. The process according to claim 17, wherein the first solvent is benzene or toluene.

20. The process according to claim 17, wherein the first solvent is toluene.

21. The process according to claim 17, wherein the second solvent is a C₁-C₁₀ alcohol.

22. The process according to claim 17, wherein the second solvent is selected from methanol, ethanol, propanol and butanol.

23. The process according to claim 17, wherein the second solvent is methanol.

24. The process according to claim 17, wherein precipitating from the first solvent is performed by adding the second solvent.

25. The process according to claim 17, wherein washing with the second solvent is carried out at a temperature between about −20° C. to about 20° C.

26. The process according to claim 17, wherein washing with the second solvent is carried out at a temperature between about −20° C. to about −10° C.

27. The process according to claim 17, wherein washing with the second solvent is carried out at a temperature of about −10° C.

28. The process according to claim 17, wherein washing with the second solvent is repeated until a clear and colorless filtrate is obtained.

29. The process according to claim 1, wherein the process is carried out in a single reaction vessel.

30. A palladium(0) phosphine complex obtainable by the process according to claim 1.
